(19) United States
(12) Patent Application Publication
(10) Pub. No.: US 2025/0136836 A1
(43) Pub. Date: May 1, 2025

(54) TWO-COMPONENT AQUEOUS COATING COMPOSITION, AND COATED ARTICLE MADE THEREFROM

(71) Applicant: GUANGDONG HUARUN PAINTS CO., LTD., Foshan (CN)

(72) Inventors: Yandan YANG, Foshan (CN); Jianguang PU, Foshan (CN); Yanfei HAO, Foshan (CN)

(21) Appl. No.: 18/835,388

(22) PCT Filed: Feb. 3, 2023
(86) PCT No.: PCT/CN2023/074400

§ 371 Date: Aug. 2, 2024

(30) Foreign Application Priority Data
Feb. 21, 2022 (CN) 202210158281.8

(51) Int. Cl. C09D 143/04; C08G 18/72; C08G 18/77; C09D 5/02; C09D 7/20; C09D 7/65; C09D 7/80; C09D 175/04

(52) U.S. Cl. CPC C09D 143/04; C08G 18/722; C08G 18/773; C09D 5/024; C09D 7/65; C09D 7/80; C09D 175/04; C08G 2150/00; C09D 7/20

(57) ABSTRACT

The present application relates to a two-component aqueous coating composition and coated article made therefrom. The two-component aqueous coating composition comprises: component A, comprising at least one silicone-modified hydroxy acrylic resin and at least one densifier; and component B, comprising at least one polyisocyanate; wherein the at least one densifier is an acrylic polymer in the form of a dry powder; and a coating formed from the two-component aqueous coating composition has a gloss of no higher than 40 at 60° using ASTM D523.

### TECHNICAL FIELD

The present application relates to a two-component aqueous coating composition and coated article made therefrom.

### BACKGROUND

At present, with the increasing awareness of environmental protection and the increasing control of solvent-based paints by various governments, paints, especially wood paints, are undergoing a comprehensive transformation from solvent-borne products to aqueous products. The water-based paint has been well developed, and the performance of water-based paint is being improved and upgraded with the requirements of use.

However, due to the curing of conventional water-based paint film-forming method leads to lack of denseness, some performance is not enough to meet the needs of consumers, such as cabinets, tables and desks need high stain resistance and anti-graffiti surface, there are also problems such as easy to stain and easy to graffiti and difficult to clean. For low-gloss paint film, especially low-gloss white paint to meet the stain resistance is more difficult; some products can meet the cleaning requirements at that time, but after many times of scrubbing, the stain resistance is obviously reduced.

Therefore, there is a need for improved long-lasting anti-graffiti and stain resistant water-based paints in the coating industry.

### SUMMARY

The present application in a first aspect provides a two-component aqueous coating composition comprising: comprising: component A, comprising at least one silicone-modified hydroxy acrylic resin and at least one densifier; and component B, comprising at least one polyisocyanate; wherein the at least one densifier is an acrylic polymer in the form of a dry powder; and a coating formed from the two-component aqueous coating composition has a gloss of no higher than 40 at 60°.

In a preferred embodiment of the present application, the component A comprises, relative to the total weight of the component A,
30 to 80% by weight of the at least one silicone-modified hydroxy acrylic resin;
0 to 45% by weight of at least one hydroxy functional polymer different from the at least one silicone-modified hydroxy acrylic resin;
2 to 10% by weight of the at least one densifier; and
0 to 20% by weight of additional additives including colorants, water, coalescents, thickeners, surfactants, defoamers, bactericides, or any combination thereof.

The present application in a second aspect provides a coated product comprising a substrate, comprising at least one major surface; and a coating applied on part or all of the main surface of the substrate that is formed from the two-component aqueous coating composition as described in the first aspect of the present application.

In the present application, it has been found that the addition of specific acrylic densifier to a two-component coating composition of silicone modified hydroxyacrylic resin and polyisocyanate provides unexpected results. Surprisingly, such combination has a synergistic effect. The above specific acrylic densifier itself is organic, good compatibility with the resin, easy to disperse, and easy to fill the substrate and the internal void of the paint film during the film formation process, adhere in the three-dimensional network structure formed by the two-component main agent and curing agent, which can form a dense paint film, so that the strength, physical properties, especially the chemical resistance of the cured coating are well improved, which is helpful to the anti-graffiti and stain resistance. In addition the densifier is distributed on the surface of the paint film to form a tiny bumpy surface, and a certain diffuse reflection of light, can play a matting effect to meet the market demand for matte products, which is unexpected.

Further, the two-component aqueous coating composition described herein provides unexpected results. For the two-component aqueous coating system, the component A includes at least one silicone modified hydroxyacrylic resin, which is prepared by first synthesizing amido acrylate emulsion and epoxy-terminated silicone oil respectively, and then introducing the silicone oil through the ring-opening reaction of the amido group and the epoxy group, which makes the introduction of silicone high and the silicone monomer easy to polymerize, so that the cured coating will have better stain resistance, water resistance and solvent resistance; for the component B, the use of water-dispersible polyisocyanate and solvent-based polyisocyanate is proportioned into curing agent according to the demand, which not only makes it easy to form a higher crosslinking density when curing the paint film, improve the mechanical properties and good chemical resistance, but also can effectively extend the usable time after paint conditioning, which is difficult to expect prior to the present application.

The details of one or more embodiments of the present application are set forth in the description below. Other features, objects, and advantages of the present application will be apparent from the description, and from the claims.

### DETAILED DESCRIPTION

As used herein, “a”, “an”, “the”, “at least one”, and “one or more” are used interchangeably. Thus, for example, a coating composition that comprises “an” additive can be interpreted to mean that the coating composition includes “one or more” additives. The use of the singular form herein is intended to include the plural form unless otherwise indicated herein.

Throughout the present application, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned in the present application, as along as such components or steps do not affect the basic and novel characteristics of the present application, but it is also contemplated that the compositions or processes may consist essentially of, or consist of, the recited components or steps.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

As used herein, “coating” has the same meaning as “paint film”, both of which are formed by applying and drying an aqueous coating composition.

When used in reference to “a densifier”, the phrase “the densifier is in the form of a dry powder” means that the densifier is in the form of free-flowable powder particles that are substantially free of water.

When used in reference to “a densifier”, the term “particle size” refers to a parameter used to measure powder particle size of a densifier in the form of a dry powder. For substantially spherical powder particles, the particle size is substantially equal to average diameter of the particles. For non-spherical powder particles, such as irregular, elongated, needle-like, fibrous, or rod-like forms, the particle size refers to the distance between the farthest ends along outer periphery of particles. In many embodiments of the present application, the particle size of the densifier can be determined by a laser diffraction particle size analyzer according to ISO 13320.

When used in reference to “an aqueous coating composition”, the expression “the coating formed from the aqueous coating composition has a gloss of no higher than 40 at 60°” means that the coating formed from the aqueous coating composition have lower gloss.

As used herein, the term “aqueous colorless varnish” refers to a clear waterborne paint that is substantially free of any colorants, and the paint film or coating formed therefrom is generally transparent or translucent. In one embodiment according to the present application, the two-component aqueous coating composition is an aqueous colorless varnish.

As used herein, the term “aqueous solid color topcoat” refers to a pigmented, colorant-containing waterborne paint with hiding power from which the paint film or coating is opaque. In one embodiment according to the present application, the two-component aqueous coating composition is an aqueous solid color topcoat.

In the context of the present application, the term “two-component aqueous coating composition” refers to an aqueous coating composition consisting of two or more separately stored components, the components of which are mixed upon application together, and can be dried and cured within an acceptable period of time to form a coating with desired mechanical properties such as hardness.

For two-component aqueous coating compositions, the “pot life” is the time it takes for the viscosity of the system to reach twice its initial viscosity at 40° C. after the two components of the aqueous coating composition have been mixed.

The terms “preferred” and “preferably” refer to embodiments of the present application that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present application.

### DETAILED DESCRIPTION

According to the present embodiments of the present application, a two-component aqueous coating composition is provided, which composition comprises: component A, comprising at least one silicone-modified hydroxy acrylic resin and at least one densifier; and component B, comprising at least one polyisocyanate; wherein the at least one densifier is an acrylic polymer in the form of a dry powder; and a coating formed from the two-component aqueous coating composition has a gloss of no higher than 40 at 60° using ASTM D523.

In an embodiment according to the present application, the densifier is an acrylics polymer in the form of a dry powder, and the dry powder has a particle size in the range of 2-10 microns. As mentioned above, the term “particle size” refers to a parameter used to measure powder particle size of a densifier in the form of a dry powder, as determined using laser diffraction particle size analyzer according to ISO 13320. It was found that the particle size of the densifier can substantially affect the chemical resistance of the coating formed from the aqueous coating composition. If the particle size of the densifier is too large, it cannot well fill voids left in the coating with the volatilization of moisture and solvents, and the improvement of the chemical resistance of the resulting coating is limited; if the particle size of the densifier is too small, it likewise cannot effectively fill the voids, and the improvement of the chemical resistance of the coating is also insufficient. Therefore, in an embodiment of the present application, acrylic densifiers with a particle size in the range of 2-10 microns are preferred. More preferably, the acrylic densifier has particle size in the range of 5-7 microns.

In some embodiments according to the present application, the acrylic densifier may be those polymers having an acrylics backbone obtained by polymerization of acrylics unsaturated monomers. Preferably, the densifier comprises at least one poly (methyl methacrylate). Such a polyacrylic densifier can be synthesized using conventional polymerization methods known to those of ordinary skill in the art, or can be commercially available, such as PMMA ultrafine powder.

In some embodiments according to the present application, the densifier is present in an amount of 1-10% by weight, preferably in an amount of 2-8% by weight, more preferably in an amount of 3-6% by weight, even more preferably in an amount of 3.5-5.5% by weight relative to the total weight of the component A. The amount of the densifier is appropriate within the above range. In some embodiments of the present application, relative to the total weight of the component A, the densifier is present in an amount of 1-10% by weight, 2-9% by weight, 2-8% by weight, 2-7% by weight, 2.5-6.5% by weight, 3-6% by weight, 3.5-5.5% by weight, 4-5% by weight, or in an amount within the range of any value within the above range.

In an embodiment according to the present application, the component A is a composition composing the body of a coating formed by an aqueous coating composition, which can be dried, cross-linked or otherwise hardened by itself or with a suitable curing agent as desired, so as to form a non-tacky continuous film on the substrate. In addition to the densifier described above, the component A comprises a silicone modified hydroxyacrylic resin.

Preferably, in the two-component aqueous coating composition according to the present application, the silicone modified hydroxyacrylic resin contained in the component A is an epoxy silicone oil modified acrylate.

According to an embodiment of the present application, the epoxy silicone oil modified acrylate is prepared by the following method: using the reaction of an amido group with an epoxy group, acrylamide is added during emulsion polymerization to introduce an amido group in the emulsion molecular chain, and then reacted with an epoxy-terminated silicone oil to prepare an epoxy silicone oil modified acrylate. Without bounding to any theory, it is speculated that for the obtained epoxy silicone oil modified acrylate, the silicone oil may be introduced through ring-opening reaction of the amido group and epoxy group, solving the problems such as the introduction of low amount of silicone, volatile organic compounds, silicone monomer difficult to polymerize and other problems caused by the conventional methods, greatly improving the water resistance, softness, stain resistance of the final resulting coating.

According to an embodiment of the present application, the amount of silicone modified hydroxyacrylic resin can vary in a wide range, and the amount can be in the range of about 20 wt % to about 85 wt % relative to the total weight of the component A. In some preferred embodiments, the amount of silicone modified hydroxyacrylic resin can be in the range of 30 wt % to 80 wt %, preferably in the range of 30 wt % to 75 wt %.

In addition to the silicone modified hydroxyacrylic resin, in the embodiment according to the present application, the component A further comprises a hydroxy-functional polymer different from the silicone modified hydroxyacrylic resin as a resin component. In the embodiment according to the present application, the hydroxy-functional polymer contained in the component A different from the silicone modified hydroxyacrylic resin comprises ethylenically unsaturated functional groups and further has a hydroxyl-functional group. In one embodiment according to the present application, the hydroxyl functional polymer has a hydroxyl value of no higher than 150 mg KOH/g using ISO 4629, preferably in the range of 40-150 mg KOH/g, more preferably in the range of 60-120 mg KOH/g, even more preferably in the range of 80-100 mg KOH/g, so as to achieve the desired curing effect. The hydroxyl number is measured by titration according to ISO 4629. If the hydroxyl value of the polymer is too high, the component A as formulated will gel quickly upon mixing with the curing agent, which is not suitable for construction operations; if the hydroxyl value of the polymer is too low, the component A as formulated will react with the curing agent slowly, resulting in a decrease in construction efficiency. Accordingly, in some embodiments according to the present application, the hydroxyl value of the hydroxy-functional polymer within the above-mentioned range is appropriate, such that the mixture by the component A as formulated with the component B has an appropriate pot life.

In some embodiments according to the present application, the hydroxy-functional polymer different from the silicone modified hydroxyacrylic resin is a hydroxy-functional polymer with ethylenically unsaturated functional groups, including hydroxy-functional epoxy (meth)acrylates, hydroxy-functional polyurethane (meth) acrylates, a hydroxy-functional polyester (meth)acrylates, hydroxy-functional polyether (meth) acrylates, hydroxy-functional polyacrylate (meth)acrylates or combinations thereof, preferably comprising hydroxy-functional polyurethane (meth)acrylates.

According to embodiments of the present application, the amount of the hydroxy-functional polymer different from the silicone modified hydroxyacrylate resin may vary over a wide range, and the amount thereof may be in the range of about 0 wt % to about 50 wt % relative to the total weight of the component A. In some preferred embodiments, the amount of the hydroxy-functional polymer different from the silicone modified hydroxyacrylic resin may vary in a range from 0 wt % to 45 wt %, preferably in a range from 0 wt % to 40 wt %.

In some of the embodiments, the component A of the two-component aqueous coating composition comprises an acrylic densifier having a specific particle size. Surprisingly, it has been found that the addition of a specific acrylic densifier to a two-component coating composition of silicone modified hydroxyacrylic resin and polyisocyanate has a synergistic effect. The specific acrylic densifier has good compatibility with the resin, is easy to disperse, and easy to fill the substrate and the internal void of the paint film during the film formation process, adhere in the three-dimensional network structure formed by the two-component main agent and curing agent, which can form a dense paint film, so that the strength, physical properties, especially the chemical resistance of the cured coating are well improved, which is helpful to the anti-graffiti and stain resistance. In addition the densifier is distributed on the surface of the paint film to form a tiny bumpy surface, and a certain diffuse reflection of light, can play a matting effect to meet the market demand for matte products.

As described above, the coating formed from the two-component aqueous coating composition according to the present application has a gloss of no higher than 40 at 60° using ASTM D523 and exhibits a low gloss effect. Preferably, the paint film formed from the aqueous coating composition of the present application has a gloss of no higher than 35 at 60° using ASTM D523, preferably a gloss of no higher than 30 at 60°, more preferably a gloss of no higher than 25 at 60°.

In some embodiments according to the present application, the coating formed from the two-component aqueous coating composition according to the present application has, in addition to the above gloss, a chemical resistance of grade 4 or higher, wherein the chemical resistance is determined according to the Examples section of the present application. Preferably, the paint film formed from the aqueous coating composition of the present application has a resistance to at least one or more or all of acids, bases, alcohols, coffee, and water of grade 4 or higher, preferably, of grade 5 or higher. In contrast, conventional waterborne topcoats with low gloss (typically considered to be a gloss of no higher than 40 at 60° using ASTM D523) on the market do not have both the required low gloss and high chemical resistance.

In the present application, the component A of the two-component aqueous coating composition according to the present application may optionally further comprise conventional additives which do not adversely affect the two-component aqueous coating composition or the cured coating obtained therefrom. Suitable additives include, for example, the agents that can improve the processability or manufacturing properties of the composition, enhance the aesthetics of the composition, or improve the specific functional properties or properties of the coating composition or the cured composition obtained therefrom (such as adhesion to the substrate), or reduce the cost. Additional additives that may be included are, for example, carriers (e.g. water), colorants (including color slurry or toners), fillers, coalescents, lubricants, wetting agents, plasticizers, surfactants, defoamers, biocides, pigments, antioxidants, flow control agents, thixotropic agents, dispersants, adhesion promoters, UV stabilizers, pH adjusters, or combinations thereof. The content of each optional component is sufficient to achieve its intended purpose, but preferably, such content does not adversely affect the two-component aqueous coating composition or the cured coating obtained therefrom. In a preferred embodiment of the present application, the component A of the two-component aqueous coating composition may optionally contain colorants, water, coalescents, thickeners, surfactants, defoamers, biocides or any of these combination as a conventional additive. According to the present application, the total amount of conventional additives ranges from 0% by weight to about 20% by weight relative to the total weight of the component A.

In a particular embodiment of the present application, the component A of the two-component aqueous coating composition comprises, relative to the total weight of the component A,
30 to 80% by weight of the at least one silicone-modified hydroxy acrylic resin;
0 to 45% by weight of at least one hydroxy functional polymer different from the at least one silicone-modified hydroxy acrylic resin;
2 to 10% by weight of the at least one densifier; and
0 to 20% by weight of additional additives including colorants, water, coalescents, thickeners, surfactants, defoamers, bactericides, or any combination thereof.

In an embodiment according to the present application, the two-component aqueous coating composition further comprises as component B a polyisocyanate.

The term “polyisocyanate” refers to a compound containing at least two isocyanate groups (−NCO). The isocyanate functional group can undergo chain extension and crosslinking reactions with the active hydrogen polymer, thereby forming a three-dimensional network structure in the coating. Suitable polyisocyanates include aliphatic polyisocyanates, aromatic polyisocyanates, or any combination thereof. The term “aliphatic polyisocyanate” as used herein refers to a polyisocyanate compound in which an isocyanate group is directly connected to an aliphatic chain or ring. The term “aromatic polyisocyanate” as used herein refers to a polyisocyanate compound in which an isocyanate group is directly connected to an aromatic ring.

As examples of suitable polyisocyanate compounds, hexamethylene diisocyanate, dodecamethylene diisocyanate, cyclohexane-1,4-diisocyanate, 4,4′-dicyclohexylmethane diisocyanate, cyclopentane-1,3-diisocyanate, p-phenylene diisocyanate, toluene-2,4-diisocyanate, naphthalene-1,4-diisocyanate, biphenyl-4,4′-diisocyanate, benzene-1,2,4-triisocyanate, xylene-1,4-diisocyanate, xylene-1,3-diisocyanate, diphenylmethane diisocyanate, butane-1,2,3-triisocyanate or polymethylene polyphenyl polyisocyanate can be used.

As examples of suitable isocyanate oligomers, polyurethane prepolymers of any of the polyisocyanate compounds listed above, polyester prepolymers of any of the polyisocyanate compounds listed above, or polyether prepolymers of any of the polyisocyanate compounds listed above can be used. The polyurethane prepolymer (for example, hexamethylene diisocyanate (HDI) trimer), polyester prepolymer or polyether prepolymer can be made by any suitable method known to those skilled in the art. For example, a polyurethane prepolymer can be made by reacting a polyol monomer with one or more of the polyisocyanate compounds under appropriate conditions; a polyester prepolymer or a polyether prepolymer can be made by reacting a polyester polyol or polyether polyol with one or more of the polyisocyanate compounds under appropriate conditions. Alternatively, as the polyurethane prepolymer, polyester prepolymer, or polyether prepolymer, any appropriate commercial product can be used. In one embodiment of the present application, the polyisocyanate includes hexamethylene diisocyanate (HDI) trimer.

In some embodiments of the present application, the polyisocyanate comprises at least one water-dispersible polyisocyanate.

In some embodiments of the present application, the at least one water-dispersible polyisocyanate is preferably a hydrophilic group-modified and/or at least partially hydrophilic group-modified polyisocyanate, more preferably a hydrophilic group-modified polyisocyanate.

In some embodiments of the present application, the hydrophilically modified polyisocyanate is non-ionic hydrophilically modified or ionic hydrophilically modified, preferably ionic hydrophilically modified.

In some embodiments of the present application, the at least one water-dispersible polyisocyanate is derived from the group consisting of 1,4-butane diisocyanate, 1,5-pentane diisocyanate, hexamethylene diisocyanate (HDI), 1,10-decane diisocyanate, cyclohexane-1,3-diisocyanate, cyclohexane-1,4-diisocyanate, 4,4′-dicyclohexylmethane diisocyanate (HMDI), cyclopentane-1,3-diisocyanate, isophorone diisocyanate (IPDI), the dimer or trimer thereof, the derivatives thereof, and any combination thereof, preferably derived from one or more of hexamethylene diisocyanate (HDI), isophorone diisocyanate (IPDI), the dimer or trimer thereof.

Preferably, in the two-component aqueous coating composition according to the present application, the at least one water-dispersible polyisocyanate used has one or more hydrophilic groups. In some embodiments of the present application, the hydrophilic group can be in the form of an acid, such as a carboxylic acid group, a sulfonic acid group, a phosphate group, a phosphonic acid group, a phosphinic acid group, and the like. Additionally, a portion of the hydrophilic group may be in the form of an acid salt, such as a neutralized acid or anhydride, for achieving a suitable stability. Examples of suitable hydrophilic groups in the form of acid salts include carboxylate (—CO₂⁻), sulfate, phosphate, sulfonate, phosphite, phosphonate, and combinations thereof. In a preferred embodiment of the present application, the anionic hydrophilic group comprises not only an anionic hydrophilic group in the form of an acid but also an anionic hydrophilic group in the form of an acid salt. Preferably, the at least one water-dispersible polyisocyanate contains a sulfonate group.

Polyisocyanates that are not modified with hydrophilic groups are generally referred to as solvent-based polyisocyanates. Usually solvent-based polyisocyanates are not adequately dispersed in aqueous systems, and have poor compatibility with water-based resin systems. However, in some cases, such as selecting a suitable cosolvent, the solvent-based polyisocyanates can be used in aqueous systems. Thus, in certain embodiments of the present application, the polyisocyanate comprises at least one solvent-based polyisocyanate and at least one cosolvent. Generally, aromatic polyisocyanates are easy to react with water, generate carbon dioxide, and easily cause yellowing of paint film. Thus, in certain embodiments of the present application, the at least one solvent-based polyisocyanate comprises an aliphatic polyisocyanate.

In the present application, the cosolvent is a solvent that helps the solvent-based polyisocyanate to disperse in the system, which is usually a water-soluble organic solvent. Suitable cosolvents are cosolvents used for conventional coating compositions, such as ethyl acetate, butyl acetate, ethylene glycol monomethyl or monoethyl ether acetate, 1-methoxy-2-propyl acetate, 3-methoxy-n-butyl acetate, acetone, 2-butanone, 4-methyl-2-pentanone, cyclohexanone, toluene, xylene, chlorobenzene, petroleum solvents (e.g. higher substituted aromatic compounds, as are available commercially, carbonic acid esters (such as dimethyl carbonate, diethyl carbonate, 1,2-ethylene carbonate and 1,2-propylene carbonate), lactones (such as β-propiolactone, γ-butyrolactone, ε-caprolactone and ε-methylcaprolactone), and propylene glycol diacetate, diethylene glycol dimethyl ether, dipropylene glycol dimethyl ether, ethylene glycol butyl ether acetate, diethylene glycol butyl ether acetate, 1,3-dioxane, N-methylpyrrolidone and N-methylcaprolactam, or any mixtures thereof.

In other embodiments of the present application, the component B comprises at least one water-dispersible polyisocyanate, at least one solvent-based polyisocyanate, and at least one cosolvent. The water-dispersible polyisocyanate has good compatibility with the aqueous film-forming composition, and the solvent-based polyisocyanate has a higher average functionality, which can increase the crosslinking density in the reaction with the film-forming resin, thereby increasing the hardness of the resulting coating, and the sandability of the paint film is further improved. In certain embodiments, the two curing agents in the component B have a specific ratio to balance the compatibility with the system and the crosslinking density, so as to achieve the maximum hardness and board surface effect. In certain embodiments, the weight ratio of the at least one above-mentioned water-dispersible polyisocyanate and the at least one solvent-based polyisocyanate is in the range of 9:1 to 1:9, preferably, in the range of 9:1: 1 to 2:8, in the range of 9:1 to 3:7, in the range of 9:1 to 4:6, or in the range of 9:1 to 5:5. In certain embodiments, the component B comprises, relative to the total weight of the component B,
30 to 99.99% by weight of at least one water-dispersible polyisocyanate;
0.01 to 50% by weight of at least one solvent-based polyisocyanate; and
0 to 20% by weight of at least one cosolvent.

As examples of polyisocyanates, any suitable commercially available product can be used, with a chemical structure based on HDI or IPDI polymer, such as hydrophilic aliphatic polyisocyanates based on hexamethylene diisocyanate (HDI) or hydrophilic aliphatic polyisocyanates based on isophorone diisocyanate (IPDI).

According to the present application, the amount ratio of the component A to the component B is in the range of 6:1 to 2:1, preferably in the range of 5:1 to 3:1. Generally speaking, when the amount ratio of the component A to the component B is greater than 6:1, the film-forming resin in the component A cannot cure well. When the amount ratio of the component A to the component B is less than 2:1, the film-forming resin in the component A will cure quickly with polyisocyanate, which will adversely affect the pot life of the two-component aqueous coating composition of the present application. According to actual needs, additional inert diluents that do not affect the reaction of the component A with polyisocyanate can be added during the preparation of component A and/or component B, for example, to reduce the viscosity of each component. Therefore, the amount of the component A and the component B is not limited to the above range, and can be adjusted according to actual needs.

In the present application, it has been found that the addition of specific acrylic densifier to a two-component coating composition of silicone modified hydroxyacrylic resin and polyisocyanate. Surprisingly, such combination has a synergistic effect. The above specific acrylic densifier itself is organic, good compatibility with the resin, easy to disperse, and easy to fill the substrate and the internal void of the paint film during the film formation process, adhere in the three-dimensional network structure formed by the two-component main agent and curing agent, which can form a dense paint film, so that the strength, physical properties, especially the chemical resistance of the cured coating are well improved, which is helpful to the anti-graffiti and stain resistance. In addition the densifier is distributed on the surface of the paint film to form a tiny bumpy surface, and a certain diffuse reflection of light, can play a matting effect to meet the market demand for matte products, which is unexpected.

It has been surprisingly found that in the two-component aqueous coating composition according to the present application, the component A contains silicone modified hydroxyacrylic resin, which by first synthesizing amido acrylate emulsion and epoxy-terminated silicone oil respectively, and then introducing the silicone oil through the ring-opening reaction of amido group and epoxy group. Thus, the amount of silicone introduced is high. In addition, the silicone monomer is easy to polymerize, which makes the cured coating stain-resistant, water-resistant and solvent-resistant. For the component B, the use of water-dispersible polyisocyanate and solvent-based polyisocyanate is proportioned into curing agent according to the demand, which not only makes it easy to form higher crosslinking density when curing the paint film, improve the mechanical properties and good chemical resistance, but also can effectively extend the useable time after paint conditioning. Surprisingly, the pot life of the two-component aqueous coating compositions according to the present application can be 2 hours or longer, for example, 3 hours or longer, at 40° C.

In one embodiment according to the present application, the two-component aqueous coating composition is an aqueous colorless varnish.

In another embodiment according to the present application, the two-component aqueous coating composition is an aqueous solid color topcoat.

According to the present application, the two-component aqueous coating composition may be prepared by simply mixing the component A with the component B in a mixing device at a predetermined weight ratio, prior to application. The mixed two-component coating composition can be applied in a variety of ways that are familiar to those skilled in the art, including spraying (e.g., air assisted, airless or electrostatic spraying), brushing, rolling, flooding and dipping. In an embodiment of the present application, the mixed two-component aqueous coating composition is coated by spraying. The two-component aqueous coating composition can be applied in various wet film thickness. In an embodiment of the present application, the wet film thickness is preferred to provide a dry film thickness in the range of about 13 to about 100 μm, preferably in the range of about 50 to 100 μm. The applied coating may be cured by accelerating drying in various drying devices e.g., ovens that are familiar to those skilled in the art.

In a second aspect according to the present application, the present application also provides a coated article comprising a substrate comprising at least one major surface; and a coating applied on part or all of the main surface of the substrate that is formed from the two-component aqueous coating composition according to the first aspect of the present application.

In some embodiments of the present article, the substrate can be any suitable substrate, including, but are not limited to wood, metal, plastic, feature, textile, ceramic or any combination thereof. Those skilled in the art will select and determine a suitable material as the substrate according to actual needs.

As the wood substrate used to manufacture the article of the present application, any suitable wood substrate known in the art can be used. In the present application, the term “wood substrate” refers to any cellulose/lignin material derived from the hard, fibrous structural organization of the stems and roots of trees or other woody plants. Wood includes, for example, hardwood and softwood wood cut directly from trees, and engineered wood composite materials made of wood strips, wood chips, wood fibers, or wood veneers. Examples of wood composite materials include, but are not limited to, plywood, oriented strand board (OSB), medium density fiberboard (MDF), particle board, and the like.

As exemplary wood substrates, hardwood, chestnut, eucalyptus, red chestnut, camellia, eucalyptus, Douglas fir, Japanese cedar, American cypress, Japanese red pine, Japanese cypress, water walnut, black walnut, maple, Japan beech, Japanese paulownia, birch, Borneo, magnolia, ash, teak, Xylosma japonicum, Catalpa wood, Dryobalanops spp., fir, oak and rubber wood.

According to the present application, the wood substrate has at least one, preferably two major surfaces facing each other. As used herein, the “major surface” is the surface for decoration formed by the length and width dimensions of the wood substrate.

According to the present application, the wood article can be prepared, for example, by the following steps: (1) providing a polished wood substrate; (2) applying the two-component aqueous coating composition according to an embodiment of the present application on the wood substrate one or more times by using a coating and curing process, to provide the wood substrate with the desired sealing properties.

According to the present application, the wood articles thus obtained can be used in the following applications, including, but not limited to: household furniture, such as tables, chairs, cabinets, etc.; bedroom and bathroom furniture; office furniture; custom furniture, such as school and children's furniture, hospitals furniture, restaurant and hotel furniture, kitchen cabinets and furniture; panels for interior design; indoor and outdoor windows and doors; indoor and outdoor window and door frames; outdoor and indoor wall panels and wooden floors.

The present disclosure is more particularly described in the following examples that are intended as illustrations only, since numerous modifications and variations within the scope of the present disclosure will be apparent to those skilled in the art. Unless otherwise noted, all parts, percentages, and ratios reported in the following examples are on a weight basis, and all reagents used in the examples are commercially available and used directly without further treatment.

### EXAMPLES

The following examples describe the present application in more detail, which are for illustrative purposes only, since various modifications and changes will be apparent to those skilled in the art from the scope of the present application. Unless otherwise indicated, all parts, percentages, and ratios reported in the following examples are on a weight basis and all reagents used in the examples are commercially available and may be used without further treatment.

### Testing Methods

Unless otherwise indicated, the following test methods were used in the following examples.

### Pot Life

The two components of the two-component aqueous coating composition according to the present application were mixed and then left to stand at 40±1° C. The starting viscosity of the system was measured in seconds(s) using a 4#Ford viscosity cup according to ASTM D1200, and the time required for the viscosity of the system to reach twice the starting viscosity was recorded.

### Scratch Resistance

The common method in the coating industry was used, specifically GMW 14698: scratching the paint film to be judged with the same strength of nail; for the obvious degree of bright mark trace of paint film, the scratch resistance was usually divided into 0-5 grades, where 5 indicated the best scratch resistance, more than 5 people for parallel test, comprehensive judgment.

### Pencil Hardness

Pencil Hardness was measured to test the hardness of a cured coating. The pencil hardness was evaluated according to GB/T6739-2006. Data was reported as the pencil hardness of the last successful test before the coating cracked. Thus, for example, if the coating did not crack when tested with a 2H pencil, but did crack when tested with a 3H pencil, the coating was reported as having a pencil hardness of 2H.

### Chemical Resistance

Tolerance tests including vinegar, lemon juice, orange juice, grape juice, ketchup, coffee, olive oil, ethanol, stain remover solutions and mustard were performed to assess the degree of “curing” or cross-linking of the coating in accordance with ANSI KCMA A161.1_2000. Finally, the integrity of the coating was determined. Chemical resistance is usually divided into 0-5 grades, where 5=the coating is intact and free of stains, no delamination (best), 4=the coating stains are barely noticeable, 3=the stained coating can be clearly identified, 2-the coating is discolored and blistered, softened, and 0=the coating has large bubbles, and has a tendency to delaminate (worst).

### Anti-Graffiti Property

The anti-graffiti property of the coating was tested according to GB/T33394-2016.

### Two-Component Aqueous Coating Composition

As shown in Table 1, the ingredients of component A in the indicated amounts were mixed to form the component A. The preparation of component B was shown as follows: mix IPDI-type isocyanate, sulfonate hydrophilic modified HDI-type isocyanate with 0-20% cosolvent DMM evenly.

The component A and the component B were mixed in certain ratio, appropriate amount of water was added, stirred well and maturated for 5-10 min before construction.

TABLE 1
Composition and Amount of Aqueous Coating Composition

| | | | | | Conventional | Conventional | Conventional | Conventional |
|---|---|---|---|---|---|---|---|---|
| | | | | | one- | two- | one- | two- |
| | | | | | component | component | component | component |
| | Example | Example | Example | Example | aqueous | aqueous | aqueous | aqueous |
| Raw materials/g | 1 | 2 | 3 | 4 | varnish | varnish | white paint | white paint |
| Component A | | | | | | | | |
| Silicone modified | 75 | 40 | 60 | 32 | | | | |
| hydroxyacrylic resin | | | | | | | | |
| Hydroxy acrylic resin | | 40 | | 32 | | 75 | | 60 |
| Acrylic Emulsion | | | | | 75 | | 62 | |
| Defoamer | 0.2 | 0.3 | 0.36 | 0.36 | 0.3 | 0.3 | 0.4 | 0.35 |
| Dispersing agent | — | — | 0.8 | 0.8 | — | — | 0.8 | 0.8 |
| Titanium dioxide | | | 14 | 14 | | | 14 | 14 |
| Densifier | 5 | 6 | 4 | 4.8 | | | 4 | 4 |
| Matte powder | | | | | 2 | 2 | 1.2 | 1.2 |
| Film-forming auxiliaries | 2 | 6 | 1.6 | 4.8 | 4 | 2 | 3 | 1.6 |
| Water | 15.7 | 6 | 17.54 | 9.74 | 16.9 | 18.9 | 13.1 | 16.45 |
| Wetting agent | 0.5 | 0.3 | 0.5 | 0.4 | 0.4 | 0.5 | 0.4 | 0.5 |
| Anti-scratch handfeel | 1 | 1 | 0.8 | 0.8 | 1 | 1 | 0.8 | 0.8 |
| additives | | | | | | | | |
| Ammonia neutralizing | 0.3 | 0.2 | 0.2 | 0.15 | 0.1 | 0.1 | 0.1 | 0.1 |
| agent | | | | | | | | |
| Thickening agent | 0.3 | 0.2 | 0.2 | 0.15 | 0.3 | 0.2 | 0.2 | 0.2 |
| Total | 100 | 100 | 100 | 100 | 100 | 100 | 100 | 100 |
| Component B | | | | | | | | |
| HDI-type isocyanate | 65 | 50 | 65 | 50 | | 80 | | 80 |
| modified by sulfonate | | | | | | | | |
| hydrophilic | | | | | | | | |
| IPDI type isocyanate | 30 | 40 | 30 | 40 | | 0 | | 0 |
| DMM cosolvent | 5 | 10 | 5 | 10 | | | | |
| PMA cosolvent | | | | | | 20 | | 20 |
| Total | 100 | 100 | 100 | 100 | | 100 | | 100 |
| Weight ratio of | 4:1 | 3:1 | 5:1 | 4:1 | | 5:1 | | 5:1 |
| component A to | | | | | | | | |
| component B | | | | | | | | |

### Coating Properties

Components A and B of Example 1-4 above were mixed, and the resulting mixture was then bladed onto a glass plate with a 100 μm wire rod. Then the pot life, chemical resistance (including the chemicals to which the wood finish surfaces was often expose), gloss (using ASTM D523), hardness, scratch resistance and anti-graffiti property of the coating compositions were determined according to the method described in the test section, and the results were summarized in Tables 2-5 below.

TABLE 2
Properties of the coatings
Comparison of varnish

| | | | Conventional | Conventional |
|---|---|---|---|---|
| | | | one-component | two-component |
| Items | Example 1 | Example 2 | aqueous varnish | aqueous varnish |
| Gloss at 60° | 35 | 34 | 35 | 35 |
| Pencil Hardness | HB | HB | 2B | HB |
| Scratch resistance | 5 | 5 | 3 | 4 |
| Pot life | 3.5 h | 4 h | — | 3 h |

Comparison of white paint

| | | | Conventional one- | Conventional two- |
|---|---|---|---|---|
| | | | component aqueous | component aqueous |
| Items | Example 3 | Example 4 | white paint | white paint |
| Gloss at 60° | 25 | 27 | 25 | 26 |
| Pencil Hardness | H | H | 2B | HB |
| Scratch resistance | 5 | 5 | 3 | 4 |
| Pot life | 3 h | 4 h | — | 2.5 h |

Note:
Scratch resistance 1-5 indicated the degree from leaving obvious marks to no marks, from poor to good.

TABLE 3
Chemical resistance of coatings
Comparison of varnish

| | | | Conventional | Conventional |
|---|---|---|---|---|
| | | | one-component | two-component |
| Items | Example 1 | Example 2 | aqueous varnish | aqueous varnish |
| Vinegar | 5 | 5 | 4 | 5 |
| Lemon Juice | 5 | 5 | 4 | 5 |
| Orange juice | 5 | 5 | 4 | 5 |
| Grape Juice | 5 | 5 | 3.5 | 5 |
| Tomato Sauce | 5 | 5 | 3.5 | 5 |
| Coffee | 5 | 5 | 2 | 4 |
| Olive oil | 5 | 5 | 4 | 5 |
| 100% ethanol | 5 | 4.5→5 | 1 | 4 |
| Stain remover | 5 | 5 | 5 | 5 |
| solution | | | | |
| Mustard | 5 | 5 | 2 | 4 |

Comparison of white paint

| | | | Conventional one- | Conventional two- |
|---|---|---|---|---|
| | | | component aqueous | component aqueous |
| Items | Example 3 | Example 4 | white paint | white paint |
| Vinegar | 5 | 5 | 4 | 5 |
| Lemon Juice | 5 | 5 | 4 | 5 |
| Orange juice | 5 | 5 | 4 | 5 |
| Grape Juice | 5 | 5 | 3 | 5 |
| Tomato Sauce | 5 | 5 | 3 | 5 |
| Coffee | 5 | 5 | 2 | 3.5 |
| Olive oil | 5 | 5 | 4 | 5 |
| 100% ethanol | 5 | 4.5→5 | 1 | 4 |
| Stain remover | 5 | 5 | 5 | 5 |
| solution | | | | |
| Mustard | 5 | 5 | 2 | 3→4 |

Note:
1-5 indicated the degree from leaving obvious marks to no marks, from poor to good.

TABLE 4
Anti-graffiti performance test
Comparison of varnish

| | | | | |
|---|---|---|---|---|
| | | | Conventional | Conventional |
| | | | one-component | two-component |
| Items | Example 1 | Example 2 | aqueous varnish | aqueous varnish |

Wiping directly with a dry rag

| | | | | |
|---|---|---|---|---|
| Whiteboard markers | 5 | 5 | 3 | 5 |
| Watercolor pen | 5 | 5 | 3 | 4 |
| Pigments | 5 | 5 | 3 | 4 |
| Ink | 5 | 5 | 3 | 4 |
| Black oil based | 5 | 4 | 1 | 1 |
| paint marker pen | | | | |
| Blue oil based paint | 5 | 4 | 1 | 1 |
| marker pen | | | | |

Wiping with 50% alcohol

| | | | | |
|---|---|---|---|---|
| Black oil based | 5 | 5 | 1 | 2 |
| paint marker pen | | | | |
| Blue oil based paint | 5 | 5 | 1 | 2 |
| marker pen | | | | |

Wiping with waterless alcohol

| | | | | |
|---|---|---|---|---|
| Black oil based | 5 | 5 | 1 | 3 |
| paint marker pen | | | | |
| Blue oil based paint | 5 | 5 | 1 | 3 |
| marker pen | | | | |

Comparison of white paint

| | | | | |
|---|---|---|---|---|
| | | | Conventional one- | Conventional two- |
| | | | component aqueous | component aqueous |
| Items | Example 3 | Example 4 | white paint | white paint |

Wiping directly with a dry rag

| | | | | |
|---|---|---|---|---|
| Whiteboard markers | 5 | 5 | 3 | 5 |
| Watercolor pen | 5 | 5 | 3 | 4 |
| Pigments | 5 | 5 | 3 | 4 |
| Ink | 5 | 5 | 3 | 4 |
| Black oil based | 5 | 4 | 1 | 1 |
| paint marker pen | | | | |
| Blue oil based paint | 5 | 4 | 1 | 1 |
| marker pen | | | | |

Wiping with 50% alcohol

| | | | | |
|---|---|---|---|---|
| Black oil based | 5 | 5 | 1 | 2 |
| paint marker pen | | | | |
| Blue oil based paint | 5 | 5 | 1 | 2 |
| marker pen | | | | |

Wiping with waterless alcohol

| | | | | |
|---|---|---|---|---|
| Black oil based | 5 | 5 | 1 | 2.5 |
| paint marker pen | | | | |
| Blue oil based paint | 5 | 5 | 1 | 3 |
| marker pen | | | | |

Note:
1-5 indicated the degree of erasure from no erasure to easy erasure, from having obvious marks to no marks

As seen from the results in Table 2-4, for the addition of specific acrylic densifier to the two-component coating compositions of silicone modified hydroxyacrylic resins and polyisocyanates, such combination had a synergistic effect, resulting in cured coatings with excellent chemical resistance, anti-graffiti and staining resistance, especially anti-graffiti properties significantly better than conventional one-component aqueous coating compositions and two-component waterborne paints.

### EMBODIMENTS

Embodiment 1: A two-component aqueous coating composition comprising:
component A, comprising at least one silicone-modified hydroxy acrylic resin and at least one densifier; and
component B, comprising at least one polyisocyanate;
wherein the at least one densifier is an acrylic polymer in the form of a dry powder; and
a coating formed from the two-component aqueous coating composition has a 60° gloss of not higher than 40 using ASTM D523.

Embodiment 2: The two-component aqueous coating composition according to Embodiment 1, wherein relative to the total weight of the component A, the at least one densifier is present in an amount of in the range of 1-10% by weight, preferably in the range of 2-8% by weight, more preferably in the range of 3-6% by weight.

Embodiment 3: The two-component aqueous coating composition according to Embodiment 1 or 2, wherein the acrylic polymer has a particle size of in the range of 2 to 10 microns, preferably in the range of 5 to 7 microns, as measured according to ISO 13320.

Embodiment 4: The two-component aqueous coating composition according to any one of Embodiments 1 to 3, wherein the at least one densifier comprises at least one polymethyl methacrylate.

Embodiment 5: The two-component aqueous coating composition according to any one of Embodiments 1 to 4, wherein the at least one polyisocyanate comprises at least one water-dispersible polyisocyanate.

Embodiment 6: The two-component aqueous coating composition according to Embodiment 5, wherein the at least one water-dispersible polyisocyanate is derived from 1,4-butane diisocyanate, 1,5-pentane diisocyanate, hexamethylene diisocyanate (HDI), 1,10-decane diisocyanate, cyclohexane-1,3-diisocyanate, cyclohexane-1,4-diisocyanate, 4,4′-dicyclohexylmethane diisocyanate (HMDI), cyclopentane-1,3-diisocyanate, isophorone diisocyanate (IPDI), the dimer or trimer thereof, the derivatives or any combination thereof, preferably derived from one or more of hexamethylene diisocyanate (HDI), isophorone diisocyanate (IPDI), the dimer or trimer thereof.

Embodiment 7: The two-component aqueous coating composition according to Embodiment 5 or 6, wherein the at least one water-dispersible polyisocyanate contains at least one sulfonate group.

Embodiment 8: The two-component aqueous coating composition according to any one of Embodiments 1 to 7, wherein the component B comprises at least one water-dispersible polyisocyanate, at least one solvent-based polyisocyanate and at least one cosolvent.

Embodiment 9: The two-component aqueous coating composition according to any one of Embodiments 1 to 8, wherein the at least one silicone-modified hydroxy acrylic resin is an epoxy-based silicone modified acrylate.

Embodiment 10: The two-component aqueous coating composition according to any one of Embodiments 1 to 9, wherein the component A comprises, relative to the total weight of the component A,
30 to 80% by weight of the at least one silicone-modified hydroxy acrylic resin;
0 to 45% by weight of at least one hydroxy functional polymer different from the at least one silicone-modified hydroxy acrylic resin;
2 to 10% by weight of the at least one densifier; and
0 to 20% by weight of additional additives including colorants, water, coalescents, thickeners, surfactants, defoamers, bactericides, or any combination thereof.

Embodiment 11: The two-component aqueous coating composition according to any one of Embodiments 1 to 10, wherein the component B comprises, relative to the total weight of the component B,
30 to 99.99% by weight of at least one water-dispersible polyisocyanate;
0.01 to 50% by weight of at least one solvent-based polyisocyanate; and
0 to 20% by weight of at least one cosolvent.

Embodiment 12: The two-component aqueous coating composition according to any one of Embodiments 1 to 11, wherein the weight ratio of the component A to the component B is from 6:1 to 2:1.

Embodiment 13: The two-component aqueous coating composition according to any one of Embodiments 1 to 12, which is an aqueous clear varnish.

Embodiment 14: The two-component aqueous coating composition according to any one of Embodiments 1 to 12, which is an aqueous solid color topcoat.

Embodiment 15: The two-component aqueous coating composition according to any one of Embodiments 1 to 14, wherein a coating formed from the coating composition has a chemical resistance of at least 4, measured according to ANSI KCMA A161.1 2000.

Embodiment 16: A coated article comprising
a substrate, comprising at least one major surface; and
the two-component aqueous coating composition according to any one of Embodiments 1 to 15 applied on part or all of the major surface of the substrate.

Embodiment 17: The coated article of Embodiment 16, wherein the substrate comprises one or more of wood, glass, ceramic, metal, plastic, and cement board, preferably wood.

While the present application has been described with reference to a number of embodiments and examples, those skilled in the art will readily recognize that changes may be made to the present application without departing from the principles disclosed in the foregoing specification. For example, without departing from the principles disclosed in the foregoing specification, the technical solutions obtained by combining multiple features or preferred modes described herein should be understood as belonging to the contents described herein. Such changes are considered to be included in the following claims unless the claims expressly state otherwise. Accordingly, the embodiments detailed herein are exemplary only and are not intended to limit the scope of the present application, which is the full scope of the appended claims and any and all equivalents thereof.

What is claimed is:

1. A two-component aqueous coating composition comprising:
component A, comprising at least one silicone-modified hydroxy acrylic resin and at least one densifier; and
component B, comprising at least one polyisocyanate;
wherein the at least one densifier is an acrylic polymer in the form of a dry powder; and
a coating formed from the two-component aqueous coating composition has a gloss of no higher than 40 at 60° using ASTM D523.

2. The two-component aqueous coating composition according to claim 1, wherein relative to the total weight of the component A, the at least one densifier is present in an amount of in the range of 1-10% by weight, preferably in the range of 2-8% by weight, more preferably in the range of 3-6% by weight.

3. The two-component aqueous coating composition according to claim 1, wherein the acrylic polymer has a particle size of in the range of 2 to 10 microns, preferably in the range of 5 to 7 microns, as measured according to ISO 13320.

4. The two-component aqueous coating composition according to claim 1, wherein the at least one densifier comprises at least one polymethyl methacrylate.

5. The two-component aqueous coating composition according to claim 1, wherein the at least one polyisocyanate comprises at least one water-dispersible polyisocyanate.

6. The two-component aqueous coating composition according to claim 5, wherein the at least one water-dispersible polyisocyanate is derived from 1,4-butane diisocyanate, 1,5-pentane diisocyanate, hexamethylene diisocyanate (HDI), 1,10-decane diisocyanate, cyclohexane-1,3-diisocyanate, cyclohexane-1,4-diisocyanate, 4,4′-dicyclohexylmethane diisocyanate (HMDI), cyclopentane-1,3-diisocyanate, isophorone diisocyanate (IPDI), the dimer or trimer thereof, the derivatives or any combination thereof, preferably derived from one or more of hexamethylene diisocyanate (HDI), isophorone diisocyanate (IPDI), the dimer or trimer thereof.

7. The two-component aqueous coating composition according to claim 5, wherein the at least one water-dispersible polyisocyanate contains at least one sulfonate group.

8. The two-component aqueous coating composition according to claim 1, wherein the component B comprises at least one water-dispersible polyisocyanate, at least one solvent-based polyisocyanate and at least one cosolvent.

9. The two-component aqueous coating composition according to claim 1, wherein the at least one silicone-modified hydroxy acrylic resin is an epoxy silicone modified acrylate.

10. The two-component aqueous coating composition according to claim 1, wherein the component A comprises, relative to the total weight of the component A,
30 to 80% by weight of the at least one silicone-modified hydroxy acrylic resin;
0 to 45% by weight of at least one hydroxy functional polymer different from the at least one silicone-modified hydroxy acrylic resin;
2 to 10% by weight of the at least one densifier; and
0 to 20% by weight of additional additives including colorants, water, coalescents, thickeners, surfactants, defoamers, bactericides, or any combination thereof.

11. The two-component aqueous coating composition according to claim 1, wherein the component B comprises, relative to the total weight of the component B,
30 to 99.99% by weight of at least one water-dispersible polyisocyanate;
0.01 to 50% by weight of at least one solvent-based polyisocyanate; and
0 to 20% by weight of at least one cosolvent.

12. The two-component aqueous coating composition according to claim 1, wherein the weight ratio of the component A to the component B is from 6:1 to 2:1.

13. The two-component aqueous coating composition according to claim 1, which is an aqueous clear varnish.

14. The two-component aqueous coating composition according to claim 1, which is an aqueous solid color topcoat.

15. The two-component aqueous coating composition according to claim 1, wherein a coating formed from the coating composition has a chemical resistance of at least 4, measured according to ANSI KCMA A161.1_2000.

16. A coated article comprising
a substrate, comprising at least one major surface; and
the two-component aqueous coating composition according to claim 1 applied on part or all of the major surface of the substrate.

17. The coated article of claim 16, wherein the substrate comprises one or more of wood, glass, ceramic, metal, plastic, and cement board, preferably wood.
